(19) United States
(12) Patent Application Publication
(10) Pub. No.: US 2006/0192364 A1
(43) Pub. Date: Aug. 31, 2006

(54) SLIKLOC security system - kingpin lock

(76) Inventor: Verne E. Thomsen, Ames, NE (US)

Correspondence Address: Verne E. Thomsen, 1681 Co Rd 16, Ames, NE, 68621, US

(21) Appl. No.: 11/067,862

(22) Filed: Feb. 28, 2005

(51) Int. Cl. B60D 1/60

(52) U.S. Cl. 280/507

(57) ABSTRACT

The SLIKLOC—Kingpin Lock is an anti-theft device used to prevent the theft of semi trailers that are unhooked from the semi tractor. The Kingpin Lock is virtually indestructible from ramming the semi tractor fifth wheel plate into the trailer Kingpin if attempted. The lock is designed to jump over the fifth wheel and lodge in front of the fifth wheel making movement of the tractor virtually impossible. The tractor's wheels will hit the semi dollies making any turns impossible. In addition, the ⅞ inch, 45 degree slant (FIG. 2) will have a tendency to catch on the front of the fifth wheel making raising the trailer to free the semi tractor fifth wheel from the trailer very difficult.

### CROSS-REFERENCE TO RELATED APPLICATIONS

Provisional Patent Application 703-746-9195 filed Jan. 16, 2004 SLIKLOC Security System—Permanent Hasp.

### Utility Patent Application for SLIKLOC Security System—Permanent Hasp filed Jan. 5, 2005.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

It has been known in the trucking industry if valuable semi-trailer loads were left unattended without being hooked up to a semi-tractor, they were subject to theft. Most kingpin locks have been very marginal in preventing serious theft. This kingpin lock is designed to prevent the lock from being destroyed with the semi-tractor fifth wheel being rammed into it and destroying the lock along with using a pagoda key, which is virtually unpickable, to unlock it.

This kingpin lock is designed to prevent using thieves tools of the trade to destroy and unlock the kingpin. (Tools such as gear pulleys, crow bars, sledge hammers, hacksaws, and chisels.)

In addition to theft prevention, it can prevent unauthorized trailers from being taken across our borders which will improve Homeland Security.

### BRIEF SUMMARY OF THE INVENTION

The SLIKLOC Security System—Kingpin Lock is an extension for added security when the semi trailers are locked with the SLIKLOC Security System—Permanent Hasp developed for truck trailer cargo vans and refrigerated vans. The SLIKLOC Security System—Kingpin Lock will prevent the theft of the semi trailers to a place where extensive break in work can be accomplished with limited fear of being discovered. The Kingpin Lock has a high degree of theft prevention for any semi-trailer.

### BRIEF DESCRIPTION OF THE SEVERAL VIEWS OF THE DRAWING

FIG. 1: SLIKLOC Security System—Kingpin Lock Insert SL0006. This is the insert that that slides in or out locking the body around the Kingpin of a semi trailer.

FIG. 2: SLIKLOC Security System—Kingpin Lock Body SL0007. This Kingpin lock body is installed over the full depth of the kingpin with the 2 and ⅞-inch hole the kingpin goes through. This covers the full kingpin with a square outside diameter that will swivel on the kingpin even when locked.

FIG. 3: SLIKLOC Security System—Kingpin Lock Body detailing the ⅞ inch, 45 degree anti-removal design after attempted theft of the semi trailer and the Kingpin Lock is positioned ahead of the fifth wheel and the side view of the Pagoda Key installation hole.

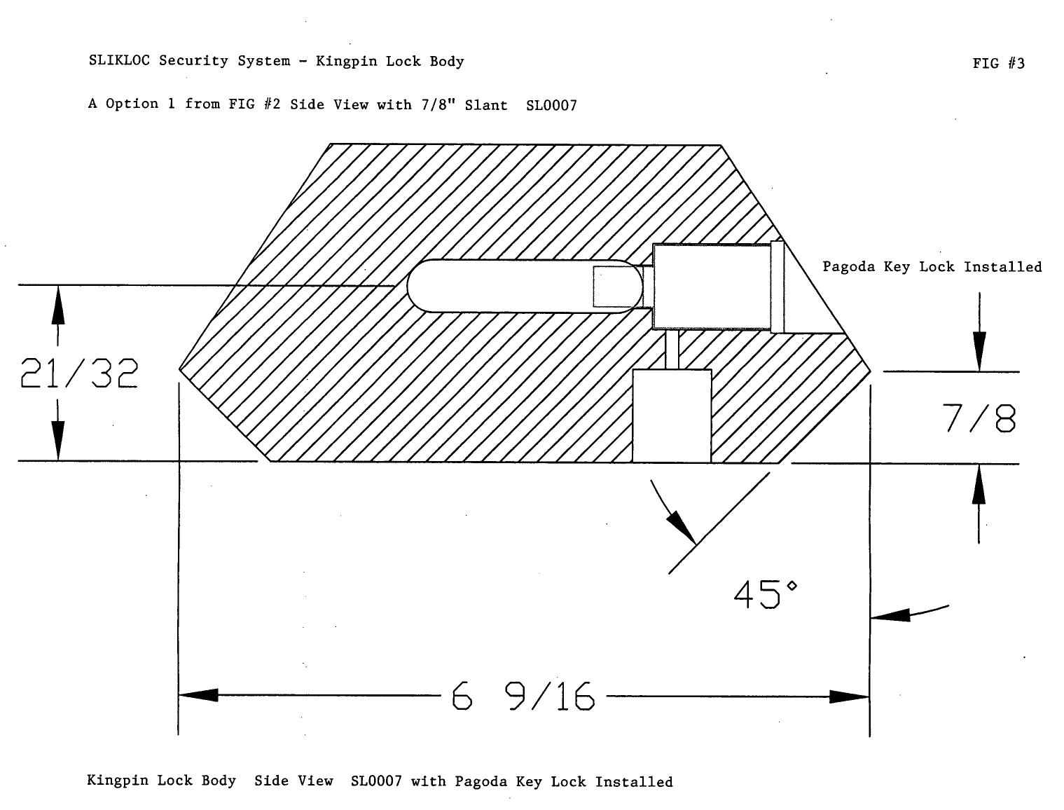

FIG. 4: SLIKLOC Security System—Kingpin Lock Body bottom view of SL0007.

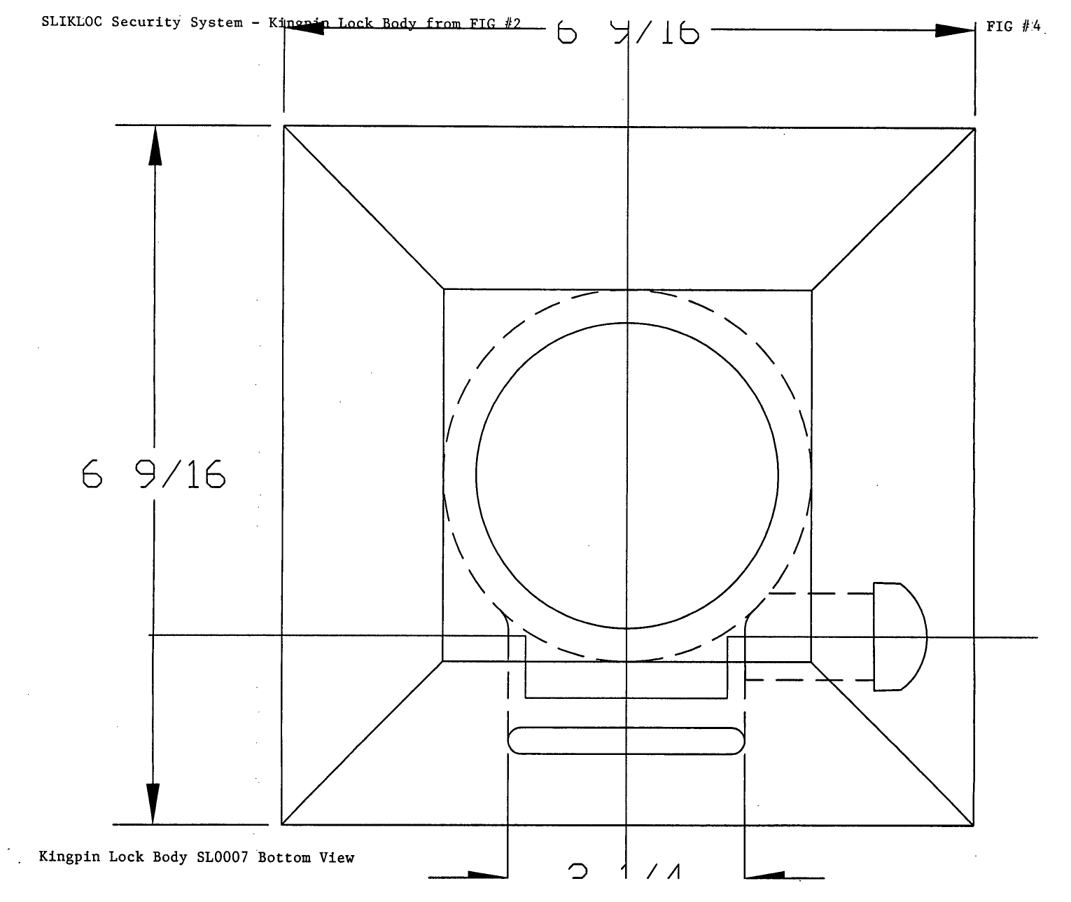

FIG. 5: SLIKLOC Security System—Kingpin Lock Body side view with inside dimensions to accommodate the kingpin.

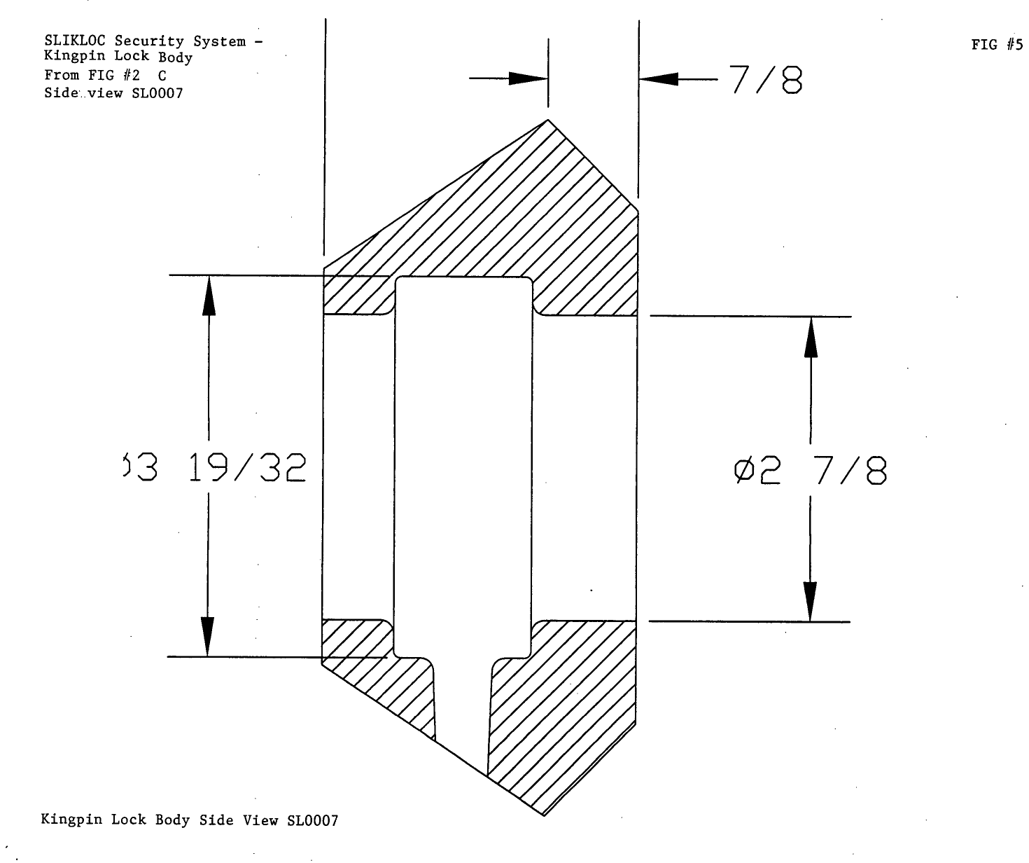

### DETAILED DESCRIPTION OF THE INVENTION

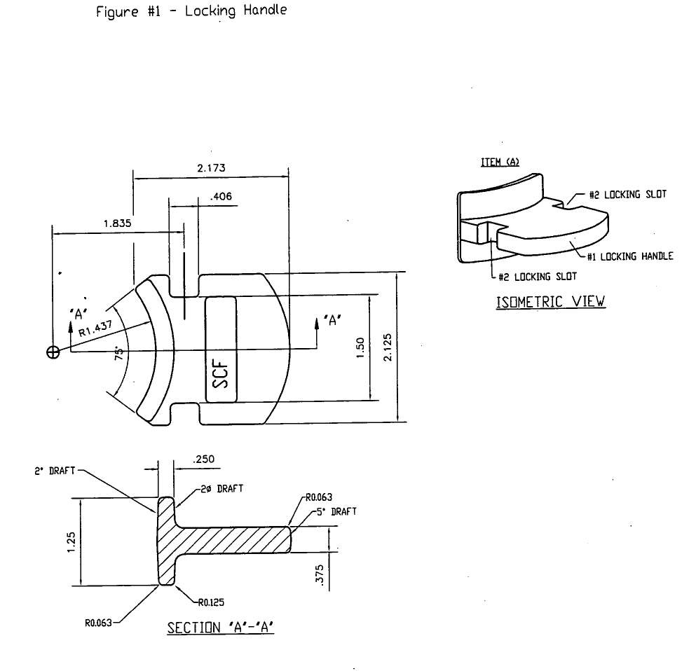

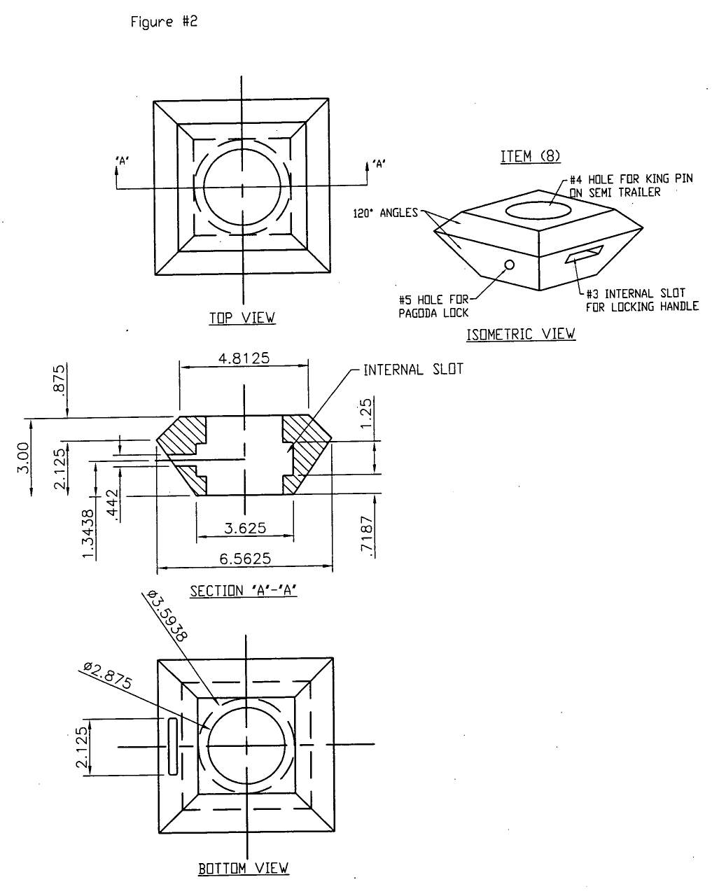

The SLIKLOC Security System—Kingpin Lock insert SL0007 is first poured out of Ductile Steel or similar hardened metal at approximately Rockwell C scale 42 to 48 and tensile strength of 50,000 to 70,000 PSI. After being poured at the foundry according to FIG. 1 showing SL0006 and FIG. 2 showing SL0007, a protective, rust proof coating is applied. Examples of the materials used in the coating are powder coatings and zinc coatings.

To install the kingpin lock, the SL0006 is inserted in the 2 and ⅞-inch home of the SL0007 which surrounds the kingpin when installed. The SL0006 slides into position filling the approximately ¾ inch indentation 1¼ inches deep on the kingpin itself.

After sliding into position the push type pagoda key lock installed in the body of the SL0007 with a 10-32 set screw accessed from the surface facing the king pin plate (not removable when installed, only when removed from the semi-trailer.) When the push type lock is locked, the shaft of the lock inserts in the space provided in SL0006 preventing removal until unlocked with the pagoda key.

The Kingpin Lock is virtually indestructible from ramming the semi tractor fifth wheel plate into the semi trailer kingpin. If this is attempted, the lock is designed to jump over the fifth wheel and loge in front of the fifth wheel making movement of the semi tractor virtually impossible. The semi tractor's wheels will hit the semi dollies making any turns impossible. The ⅞ inch, 45 degree slant shown in FIG. 2 will have a tendency to catch on the front of the fifth wheel making raising the trailer to free the semi tractor fifth wheel from the trailer very difficult and time consuming.

1.-4. (canceled)

5. A locking device with a locking body comprising a solid piece housing square, with 120 degree angles:
(a) said angles form a V formation from the bottom of the base to a point ⅞ inch from the top of the base, approximately two inches, and from the top of the base to a point ⅞ inch from the top of the base for theft prevention.
(b) said angles leave the locking body free to rotate on the kingpin of the semi trailer when the fifth wheel of a semi tractor is used to ram against the locking body making it impossible to pick up the trailer with the tractor.
(c) said locking device with said angles, when rammed with a semi tractor, will cause the semi trailer kingpin with locking device engaged to jump over the fifth wheel of the semi tractor, causing the trailer to become stuck on the frame ahead of the fifth wheel of the semi tractor, which will take raising the semi trailer approximately 18 inches to free the trailer from the tractor.

6. Said locking device with a locking handle that slides inside the locking body:
(a) said locking handle slides vertically into the slot of the kingpin lock performing the locking action which prevents removal of the locking body from kingpin on the semi trailer.

7. Said locking device uses a push button pagoda key:
(a) said push button pagoda key fastens the locking handle preventing sliding of said handle away from semi trailer kingpin preventing removal of the locking body.
